(19) United States
(12) Patent Application Publication
(10) Pub. No.: US 2011/0202967 A1
(43) Pub. Date: Aug. 18, 2011

(54) Apparatus and Method to Broadcast Layered Audio and Video Over Live Streaming Activities

(75) Inventors: Jonathan Hecht, Chicago, IL (US); Ivan Meyers, Potomac, MD (US)

(73) Assignee: VOICE THE GAME, LLC, Rockville, MD (US)

(21) Appl. No.: 13/027,064

(22) Filed: Feb. 14, 2011

Related U.S. Application Data
(60) Provisional application No. 61/303,907, filed on Feb. 12, 2010.

(51) Int. Cl. H04N 7/173

(52) U.S. Cl. 725/114

(57) ABSTRACT

Systems and methods for creating customized, personalized broadcasting content, and for broadcasting the created content are disclosed. A computer automated system comprised of a memory coupled to a processing unit includes means to receive audio and video data of an event. The system further includes a server to encode and transcode the received data, and to standardize the received data to internal presets. Timecode is embedded in the received data if it is not already present and a low resolution proxy of the standardized data is streamed to a commentator's computer through which commentary is added. The added commentary is transmitted back from the commentator computer and combined with the commentator audio stream with the audio and video data of the event. The resultant stream is buffered and then broadcast as well as archived.

### CROSS-REFERENCE TO RELATED APPLICATIONS

This application claims priority to U.S. Provisional Patent Application No. 61/303,907, and entitled “Apparatus and Method to Broadcast Voice Over Live Streaming Activities” filed on Feb. 12, 2010.

### FIELD OF THE INVENTION

The present invention relates generally to systems and methods for creating broadcastable content on computer networks, and more specifically, to a system and method for creating personalized layered audio and video streams for broadcasting. Yet more specifically, the invention relates to systems and methods enabling users to create user-customized broadcastable content over a live streaming program for use in social media distribution.

### BACKGROUND

Computers and the internet have revolutionized the ways by which live content can be broadcast to users. With the advent of Internet TV, there have been even more substantial technological advancements in creating content that can be broadcast. Initially, IPTV realized an additional distribution channel for broadcasting television programs, including live broadcasts of games, specifically sporting events. Sophisticated software developed now enables live online broadcasts with little or nominal delay.

However, despite advancements, to this day, online broadcasting remains just an alternative to conventional broadcasts, with little or no customization and value adds. There thus remains a need for customizable, personalized broadcasts and for a system and method that can enable the effective creation of such customizable, personalized broadcasts.

Existing software suites enable streaming of an event, program or other broadcastable content, but do not account for adding narration, commentary, and other voice over types during or after the event/program/content from another location. Other existing professional audio and video solutions offer the traditional, “physical” combination of audio/video for live production. While they can be automated, such implementations can only handle one event at a time. A need remains for a system and method that can handle multiple events simultaneously, inexpensively, and is entirely TCP/IP and database-driven, leveraging the power of the internet without the need for expensive, bulky, non-multitasking, traditional video control rooms requiring many personnel. There remains a further need for systems and methods that enable users to create personalized, layered audio and video streams for use in social media distribution or/and for distribution to larger audiences. Embodiments disclosed address precisely such a need.

### SUMMARY

In light of the foregoing, a need in the art exists for methods and systems to broadcast content online. An embodiment that substantially fulfills this need includes a computer automated system comprised of a memory coupled with a processing unit, which has instructions encoded thereon. The instructions allow for the computer automated system to: receive audio and video data of an event; encode or transcode the received data; standardize the received data to internal presets; embed timecode into the received data if it is not already present; stream a low resolution proxy of the standardized data via a streaming server to a commentator computer; receive a commentator recorded audio stream, which is combined with timecode metadata from the proxy stream and transmitted back from the commentator computer; combine the commentator audio stream with the audio and video data of the event; buffer the resultant combined audio and video stream; broadcast the stream via the streaming server; and archive the stream to a video repository.

The embodiment includes a system for broadcasting, comprised of a data center which further comprises a single or plurality of video and audio receivers, a server for encoding and transcoding of data, a streaming server, a video repository, a buffering means, a signal combining means, a single or plurality of ingest servers, and a web server comprising a database, and further comprising means for serving content, scheduling, and automating tasks. In a preferred embodiment, the system further includes software and other appropriate means for adding timecode to content such that raw content can be streamed to a commentator's computer (for creating commentary) through very low bandwidth internet connections, minimally defined as a 56 kbps-rated dial-up connection, though optimal quality for a more satisfying user experience would mandate at least a 512 kbps broadband connection.

The embodiment further includes a method for customizable, personalized broadcasting of content, comprising: receiving audio and video data of an event; encoding or transcoding of the received data; standardizing the received data to internal presets; embedding timecode into the received data if it is not already present; streaming a low resolution proxy of the standardized data via a streaming server to a commentator's computer; receiving a commentator-recorded audio stream, which is combined with timecode metadata from the proxy stream, and transmitted back from the commentator computer; combining the commentator audio stream with the audio and video data of the event; buffering the resultant combined audio and video stream; broadcasting the stream via the streaming server; and archiving the stream to a video repository.

In the method described above, the audio received preferably includes natural audio, i.e. surrounding sounds. The received video and audio stream is then passed to a transcoding server, where the received data is standardized to internal presets. During the standardization, timecode is added if it is not already present. A low resolution proxy of the standardized data is then streamed via a streaming server to a commentator's computer with the associated timecode. The commentator records a new audio stream, which is combined with timecode metadata from the proxy stream and transmitted from the commentator computer back to the datacenter, where it is received by one of the ingest servers. The resultant audio and video stream is buffered at the data center, and passed to the streaming server which broadcasts the received stream to end users even while simultaneously archiving the stream to a video repository. The video and audio of the event in question can be acquired by anything from a webcam to a traditional or professional multi-camera video shoot. The video will be transmitted through either software or hardware encoding to the data center, via the internet. Only video and natural audio from the event will be transmitted.

### BRIEF DESCRIPTION OF THE DRAWINGS

Other objects and features of the present invention will become apparent from the following detailed description considered in connection with the accompanying drawings, which disclose several embodiments of the present invention. It should be understood, however, that the drawings are designed for the purpose of illustration only and not as a definition of the limits of the invention.

FIG. 1 shows a block diagram of the apparatus implementing the present invention.

FIG. 2 shows a block diagram illustrating several components of the data center of FIG. 1 used to receive audio/video, add timecode, transmit the received audio/video to a commentator's computer, receive the commentary created by the commentator, and broadcast the created content.

FIG. 3 shows a flowchart illustrating a user/commentator experience.

FIG. 4 illustrates the commentator's hardware and software in further detail.

FIG. 5 illustrates signal combination of the system of FIG. 1.

FIG. 6 illustrates an embodiment with telestrator functionality.

FIG. 7 is an overview flow diagram illustrating the method and logic implemented, via a website which acts as a user interface, and the resulting social experience for the user.

### DETAILED DESCRIPTION

In the following description, for purposes of explanation, numerous specific details are set forth in order to provide a thorough understanding of the invention. It will be apparent, however, to one skilled in the art that the invention can be practiced without these specific details.

The following terms have these corresponding definitions in the description:

TIMECODE: A timecode is a sequence of numeric codes generated at regular intervals by a timing system. Timecode is used extensively for synchronization, and for logging material in recorded media. Timecode is added to film, video or audio material, and has also been adapted to synchronize music. It provides a time reference for editing, synchronization and identification. Timecode is a form of media metadata, and there are various formats defined by the Society of Motion Picture and Television Engineers (SMPTE) including, but not limited to Linear timecode, Vertical interval timecode, Burnt-in timecode, CTL timecode, MIDI timecode, AES-EBU embedded timecode, Rewritable consumer timecode, and Keykode.

ONE EMBODIMENT or AN EMBODIMENT: reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

TELESTRATOR: A telestrator is a device or method allowing a user to draw a freehand sketch over a motion picture image.

Those skilled in the art will appreciate that the present invention may be implemented with many different types of computer system configurations, including hand-held devices, multiprocessor systems, microprocessor based or programmable consumer electronics, network personal computers, tablets, minicomputers, mainframe computers, and the like. The present invention can also include multiple computer programs which embody the functions described herein and illustrated in the drawings, flow charts, and programming logic. However, it should be apparent that there could be many different ways of implementing the invention in computer programming, and the invention should not be construed as limited to any one set of computer program instructions. Furthermore, a skilled programmer would be able to write such a computer program to implement the disclosed invention without difficulty based on the drawings, flow charts, and programming logic and associated description in the application text, for example.

Therefore, disclosure of a particular set of program code instructions is not considered necessary for an adequate understanding regarding how to make and use the invention. The inventive functionality of the claimed invention will be explained in more detail in the following description in conjunction with the remaining Figures illustrating the functions and program flow. Certain steps in the program flow described below must naturally precede others for the present invention to function as described. However, the present invention is not limited to the order of the steps described if such order or sequence does not alter the functionality of the present invention. That is, it is recognized that some steps may be performed before or after other steps or in parallel with other steps without departing from the scope and spirit of the present invention.

Embodiments disclosed recite a system and method that would enable any user to broadcast his or her voice over a live streaming program, more particularly, though not limited to, a sports event. An online event stream would include live video and live sounds from the event. Live sounds and “natural audio” as described in a preferred embodiment include but are not limited to: surrounding sounds from the game, from the fans, quotes from the field, surrounding noise, cheers, weather effects from spectators witnessing the game, etc. A commentator user can draft all commentary and create content that can be broadcast to an end user audience. Additionally, an end user audience can select and listen to other commentator user-broadcasters while watching streamed live games. Broadcasters are allowed the ability to record, save and share their broadcasts with an online community. A user-commentator is enabled to create content that can be broadcast to any user who has access to the internet. With a data center that ties video from any event with originally drafted external commentary, users are enabled with the ability to connect, create, view, and/or listen in on live broadcasts from all over the world via an online community.

Traditional TV networks broadcast events along with commentary, usually by professional, paid commentators. Some networks stream such events online, also with professional commentary. Embodiments disclosed allow end user audiences to tune in to commentary-free streams over the internet and add their own commentary for others to hear in a self-service manner. Effectively, the audience user is enabled to become the commentator user. Embodiments disclose online networks to enable broadcasting of original content over live stream footage in sports, and in other fields as well, with the ability for broadcast-inclined fans to announce the game or other event, to friends and family without needing a traditional broadcast crew in place. Effective content building can span a variety of realms, from a local soccer match to a professional sporting event which may or may not already be the subject of a professional, traditional broadcast. Events that would be too expensive for traditional television networks to cover can now be made available to users via the internet. Embodiments disclosed leverage the power of the internet, wherein the system and method can embed social networks or can be embedded and uniquely combined with social networking sites to offer the user/broadcaster, and the viewer a wholly personalized, customized experience, among a group, a fraternity, a real or virtual community, or/and globally.

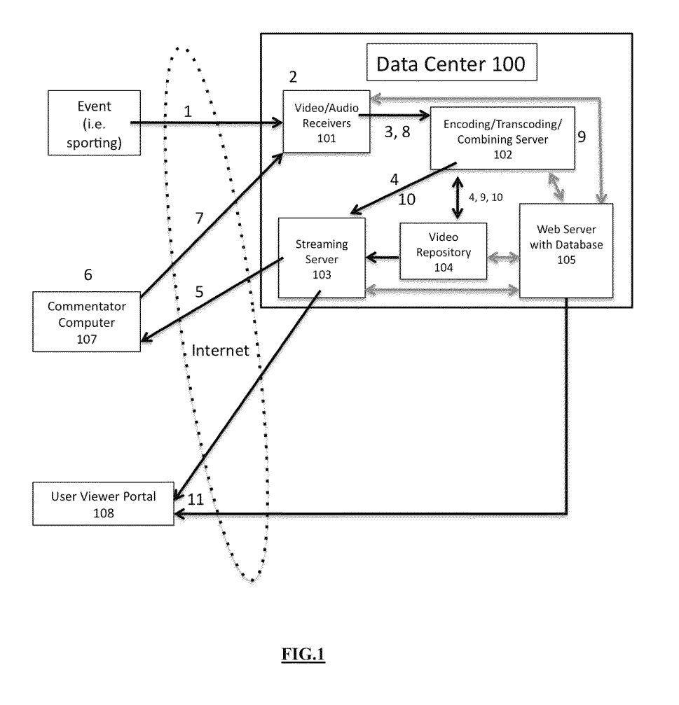

FIG. 1 shows a block diagram of the apparatus implementing an embodiment of the present invention. A system for broadcasting comprises a data center 100. In the data center, video and audio stream flow is represented by black arrows. Additional supporting communication is represented by grey arrows. The data center is further comprised of video and audio receivers 101 which include means for receiving video and audio from an event. A server 102 operates for encoding and transcoding of passed data. The server 102 further comprises means for creating and adding timecode or/and sync marks to the passed data, as well as buffering, splitting, and combining individual signals. A streaming server 103 streams a proxy video and added timecode to a commentator computer 107, and also serves to broadcast video and audio, including added commentary to a user viewer portal 108 along with simultaneously archiving the data stream to a video repository 104. In addition to a video repository, the data center includes a web server 105 comprised of a database, and means for serving content, and for scheduling and automating tasks. In a preferred embodiment, the system further includes software and other appropriate means for creating and adding timecode or/and sync marks to content such that raw content can be streamed to a commentator's computer (for creating commentary) through very low bandwidth internet connections. Raw, proxy videos are low quality images which can be streamed using much lower bandwidth than high quality images. Although DSL connections with at least a 512 kbps bandwidth would be preferred, there is still a sizable population of subscribers that use dial-up with speeds as low as 33 kbps. Thus, streaming of proxy video images that consume lower bandwidth can be extremely advantageous.

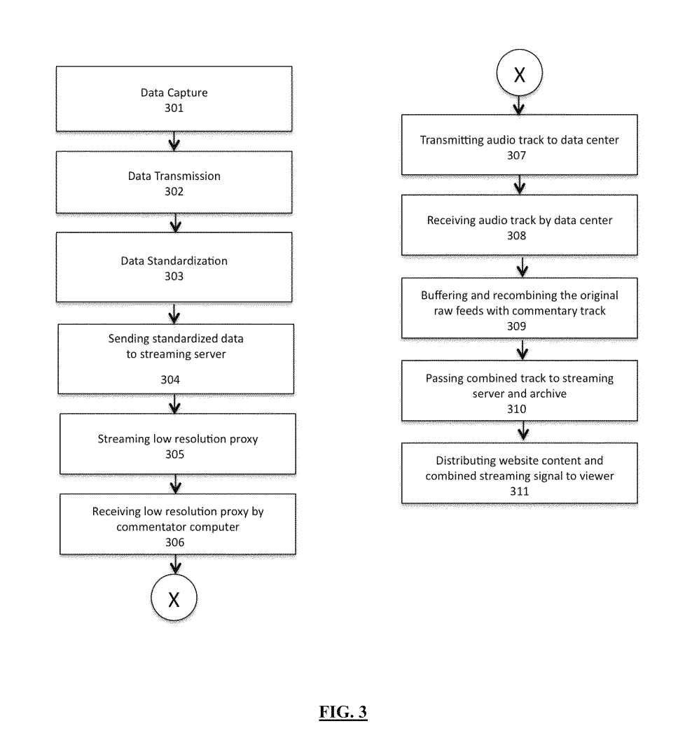

FIG. 1 additionally demonstrates a step by step user experience discussed and described below in further detail, with respect to the flowchart of FIG. 3. In step 1, video and audio originate from an event, and are transmitted over TCP/IP via software transport, hardware encoder, or built-in service. In step 2, video and audio receivers receive video and audio from the event. In step 3, the received data is encoded and/or transcoded, and timecode or/and sync marks are added to the passed data. In step 4 the encoded/transcoded data is sent to the streaming server. In step 5 the raw event feed (proxy video) with added timecode is distributed to commentator(s) via TCP/IP. In step 6, the commentator software receives raw game footage and records narration, adding sync marks to narration to video. Step 7 entails sending an audio-only track back to the data center with sync marks, via TCP/IP. In step 8, the received, time coded commentary stream is sent to the encoding/transcoding server, where, in step 9, the commentary stream is buffered and combined with the original raw video and audio of the event. Step 10 includes broadcasting the combined stream via the streaming server and archiving the stream in the video repository. Step 11 entails broadcasting to the viewer portal via the web server and database.

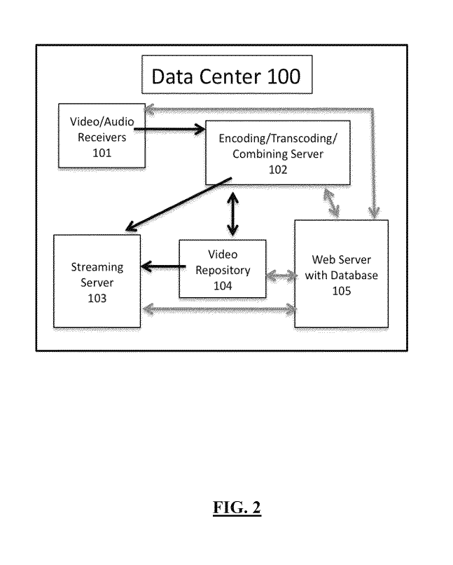

FIG. 2 shows a block diagram illustrating several components of the data center of FIG. 1 used to receive audio/video from an event and from a commentator computer (video/audio receivers 101), create and add timecode or sync marks (encoding/transcoding server 102), transmit the received audio/video to a commentator's computer via streaming server 103, combine the commentary with natural audio from the venue, broadcast the created content via the streaming server 103 or/and the web server with database 105, and store the created content in a video repository 104.

A potential commentator user can schedule an event through a user interface, provided through an interactive website. This prepares the data center by allowing automatic reservation of audio/video ingest “slots” as well as processing power and storage space. Alternate embodiments allow a user commentator to enter an event without a scheduling or in general anytime during an ongoing event and create broadcastable content thus, as would be apparent to a person having ordinary skill in the art. The database is the key to holding the entire system together, as it will trigger, and be triggered by, all the other related systems. For example, users can schedule events on the website, through which a database record for that event is created. The database, in turn, would then trigger scheduling and allocation of streaming equipment. When the stream begins, the streaming server will check in with the database to validate the session, and the database will turn the stream over to the encoders and storage space. The database keeps track of all this information not only for dynamic resource allocation but for future playback and seamless integration with web user experience.

FIG. 3 is a flowchart diagram that illustrates, step by step, user/commentator experience during an event. The method 300 starts at step 301 wherein an event is captured via video and audio. The event capture can be executed by anything from a webcam to a traditional or/and professional multi-camera video shoot.

In step 302 the video will be transmitted through either software or hardware encoding to the data center, via the internet. Only video and natural audio from the event will be transmitted. Alternate embodiments may transmit any live commentary as well; such commentary can be subsequently removed. IP-based video transmission can be implemented using H.264 or variants of it, known to a person having ordinary skill in the art. IP-based audio transmission is implemented using SILK codec (developed by Skype) or similar variants known to a person having ordinary skill in the art. The audio and video data stream of the event is received at the data center via TCP/IP hardware or software decoders. The data center can be pre-programmed to be aware of the event and to expect the streams.

Step 303 entails encoding or transcoding the received data by passing the incoming video/audio stream to an encoding/transcoding server, and standardizing the received data to internal presets. This step also entails checking for timecode, and creating and adding timecode or/and sync marks if it is not already present. The transcoding server (or servers) runs programs such as FlipFactory and Pipeline; the purpose is to standardize the video to configurations that optimize streaming and archiving. The web server would run Apache, Microsoft IIS, or similar product well known to a person having ordinary skill in the art. The database server would run MySQL, SQL Server, or similar variation well known to a person having ordinary skill in the art. Scalability for distribution of the data is done using Akamai or its equivalent, as would be apparent to a person having ordinary skill in the art.

In step 304, the standardized data is sent to the streaming server, from where the standardized data or “raw” audio/video is distributed simultaneously to a commentator computer or computers, and to a video repository. The standardized “raw” data is saved in the video repository for future access. The video repository would be a large repository, most likely a server utilizing RAID 1 or 5 (or a combination thereof), or similar product that offers protected data storage.

Step 305 demonstrates streaming a low resolution proxy of the standardized data via the streaming server to the commentator's computer. Streaming a low resolution proxy lowers the bandwidth requirement significantly. It is also possible to stream a low resolution proxy of only the video to further lower the bandwidth consumption. In an embodiment, the low resolution proxy is streamed across to the commentator's computer, with added or created timecode embedded in the data stream.

When the commentator computer receives the raw, low resolution proxy video and audio stream in step 306, the stream is presented to the commentator for adding commentary via a microphone hooked to or built into the computer. While software and other related means are employed to reduce any audio feedback, as would be apparent to a person having ordinary skill in the art, preferred embodiments utilize headphones so that the audio feedback is minimized. The commentator can then announce the game as seen. The software allows the commentator to indicate the preferred mix level, and a preferred embodiment allows for an auto setting by default. As the audio is recorded, the same timecode from the raw stream is encoded to the new audio commentary feed, buffered locally on the computer, and transmitted back to the data center in step 307. While the client computer could combine the commentator audio with the original audio/video stream and send it back to the data center, ideal embodiments deploy timecode or/and sync marks in all audio and video streams where only the commentary stream is sent back to the data center. This allows for thinner client software and hardware, reduces stress on the CPU and prevents overloading of the upload throughput of the combined signal. This also results in a higher-quality end product, especially since upload speeds in home internet connections are usually lower than download speeds. Furthermore, it is highly advantageous, especially at a location without dedicated internet where an alternate connecting means, such as a cellular network, is relied upon to transmit video or audio. Additionally, this also allows for seamlessly integrating commentator software and hardware into portable computing devices like cell phones, tablets, PDA's, etc. as would be apparent to a person having ordinary skill in the art. The utilization of embedded timecode or any other syncing means mitigates the possibility of the announcer's voice falling behind the original event video.

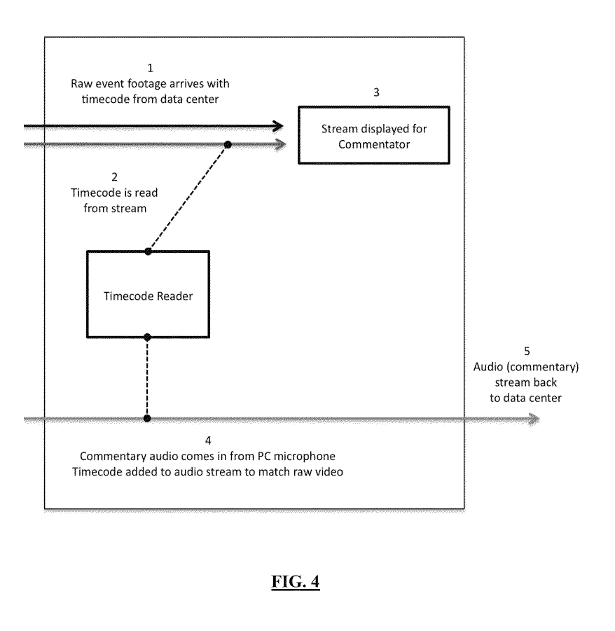

FIG. 4 illustrates the commentator hardware and software in further detail. Referring to FIG. 4, step 307 (from FIG. 3) represents an audio-only commentary track with timecode (“sync marks”) transmitted back to the Data Center. FIG. 4, sub step 1 shows raw event footage arriving with timecode from data center; sub-step 2 shows timecode being read from the data stream; in sub-step 3 the stream is displayed for the commentator; in sub-step 4 timecode is added to the commentator recorded audio stream arriving from the PC microphone; and in sub-step 5 the recorded audio stream is sent back to the data center.

Step 308 demonstrates receiving the commentary stream at the data center wherein the stream is audio-only from the commentator, marked with embedded timecode or sync marks in order to be processed.

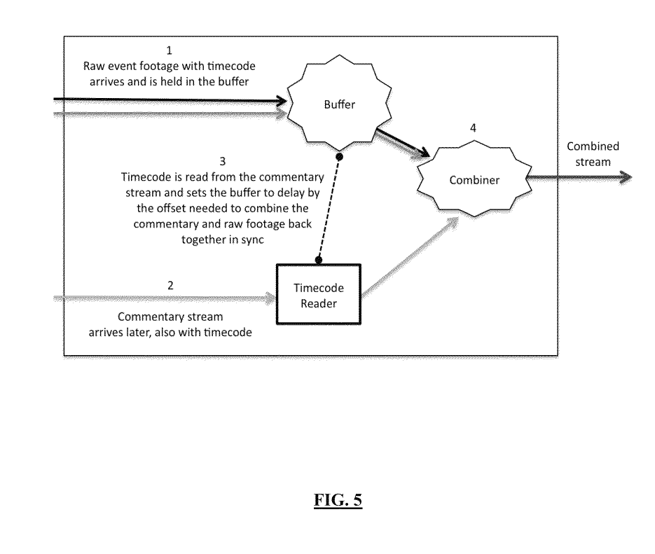

In step 309, the timecode in the audio-only commentary is used to buffer the original raw video and audio event stream, and the two are combined accordingly, resulting in video and audio from the event, now with a commentary track. Step 309 is further illustrated in FIG. 5. FIG. 5 illustrates signal combination of the system of FIG. 1. The illustrated means of signal combination comprises a buffer, a timecode reader, and a combiner. Raw event footage with timecode arrives in and is held in the buffer (sub-step 1). A commentary stream arrives later, also with timecode, and passes through a timecode reader (sub-step 2). Timecode is read from the commentary stream, and the buffer is set to delay by the offset needed to combine the commentary and raw footage back together in sync (sub-step 3). A combiner serves to layer the raw footage and commentary streams, integrating the two into one combined stream, synced with the help of the timecode (sub-step 4).

Step 310 involves passing and/or buffering the resultant combined audio and video stream to the streaming server.

Step 311 demonstrates broadcasting the stream via the streaming server and archiving the stream to a video repository, wherein the buffered game stream is passed to the streaming server and then distributed, and sent for archiving to the video repository for later viewing. The combined signal is distributed to any subscriber or non-subscriber user, usually a “home viewer” who tunes in to the event. Distribution to the end user occurs from the web server and streaming server. Home viewers do not have to be at home to view the event, as anyone with a computer, laptop, or mobile version of viewing/commentating software (with internet connectivity) would be able to receive this feed. This can be delivered via a user interface, usually in a web page, with embedded video/audio. Additional embodiments include means for creating or/and formatting content for three dimensional (3D) television, 3D PC, and 3D portable computing screens. Alternate embodiments incorporate commentator videos into the system as well as means for uploading multiple original cameras from the event site so that the commentator, and preferably the viewer as well can choose from which angle to view the game. In some embodiments, instant replay functionality is built into the camera software. An additional embodiment incorporates a “control room” like facility for the commentator, wherein rather than simply receiving the switched feed for a multi-camera event, the commentator would see each source individually (Camera 1, Camera 2, Camera 3, etc.) in one corner of the screen, streamed as an even lower quality proxy. The commentators would then be able to click on which angle(s) they would like to transmit to viewers in high quality. Transitions between cameras and graphics that include player and team stats, etc. can also be integrated. Thus, the commentator can control virtually the entire user viewing experience, aside from the actual camera shots. Embodiments disclosed also include the ability for users to create a highlight reel from archived footage of one or several games, and save that in a memory bank for “highlights”. Additionally, alternate embodiments include an ability to voice a game that has already finished. An embodiment interface provides for permissions for certain games to be “re-broadcast”, and the system allocates resources to re-stream from the streaming server in its raw format. Another embodiment feature includes multiple games open at once for voicing accomplished by having multiple commentary windows, which can be opened simultaneously in the user interface. Other variations and modifications are possible, as would be apparent to a person having ordinary skill in the art.

An alternate embodiment provides an ability to have two or more commentators complementing one another from different locations. Their commentary would be transmitted as a joint broadcast on one channel, so that users tuning in could hear both commentators delivering a broadcast on the same video despite the audio originating from different computers. Preferably, when commentator users are scheduling or reserving a time for a game (or even joining a game), they can invite others to join in their commentary. In one embodiment, this broadcast is a closed environment, wherein only the originator of the scheduling and their invitees can participate in the broadcast as broadcasters. All others who want to participate (but have not been invited) will only be listeners/viewers. Additionally, all commentary can also be seen by announcers as a text stream, so that commentators/announcers can view what they are broadcasting, review and analyze their language and their subject matter. The text stream will also allow users who are deaf the ability to still commentate and improve their speech.

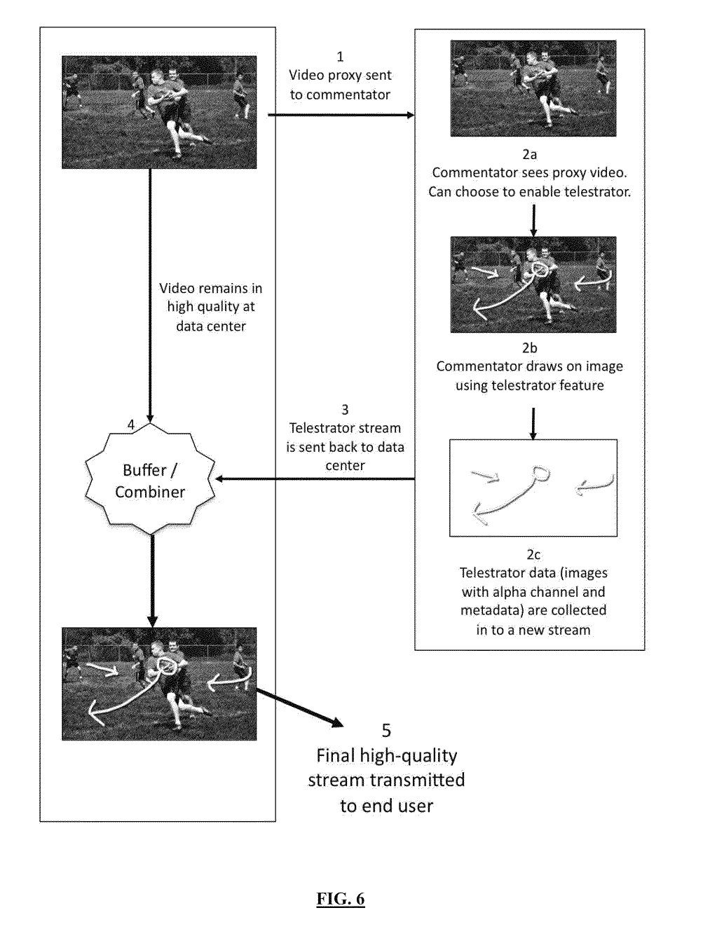

An embodiment can include an instant replay feature which further incorporates telestrator functionality. FIG. 6 illustrates telestrator functionality in an embodiment. A telestrator icon or label on the user interface can serve to activate the telestrator, which can turn the mouse in to a paint brush and allow the user to click and drag on the screen to create diagrams over a frozen picture, as illustrated in FIG. 6. The proxy video in the commentator software would have pause, replay, and motion control buttons (for slow motion, etc.), and when the telestrator feature is enabled, the interface will let the commentator user draw onto and over the video stream. The drawn image would be captured as a series of png files with alpha channels (for use in layering against the original video) and transmitted back to the data center either as a newly-formed stream or a series of png images in regular intervals (every second, for example), with timecode embedded either in the metadata of the transmission or of the png file itself. At the datacenter, the png files would be layered with the original broadcast and combined with the original video. Diagrams created by the commentator can thus be embedded in the final live broadcast for the viewer to see. In an embodiment, a “clear telestrator” button provided allows the user to start another diagram or move on. Additional options like brush color and weight, the capability to play video in slow/regular/fast speed, with motion underneath the diagramming can be provided along with other alternatives, as would be apparent to a person having ordinary skill in the art.

FIG. 6 sub-step 1 illustrates the video proxy being sent to the commentator; in sub-step 2a, the commentator may choose to enable the telestrator functionality; sub-step 2b illustrates the telestrator functionality when it is enabled; sub-step 2c shows how telestrator data is collected into a new stream; in sub-step 3, the telestrator stream is sent back to the data center; sub-step 4 illustrates the buffering and combining step including the telestrator data; and sub-step 5 illustrates the final, high quality stream being broadcast to the end user.

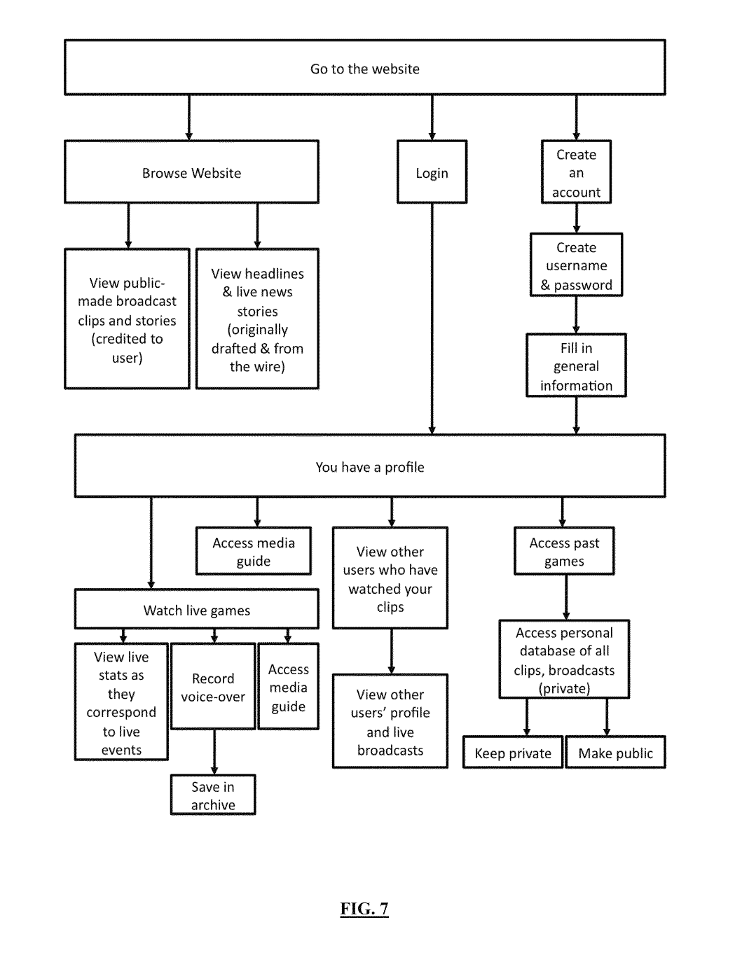

FIG. 7 is an overview flow diagram illustrating the method and logic implemented via a website that acts as a user interface, and the resulting social experience for the user. Through the user interface, a user can either browse to view headlines and live news stories, either originally drafted from wire or elsewhere, view broadcasts including clips and stories put together by other users, or/and create a username and password, and fill in and complete profile information to sign up for membership. Such information may include name, username, sex, hometown, broadcast location, favorite team(s), favorite player(s), general or specific information a user may want to project and share in an “about me” section, email id, website, education, etc.

With a username and password, and a completed profile, users will be able to gain access to various features. Users can access their previously recorded games, view other users' information/profiles including those who have watched their clips or broadcasts, and watch and access media guides during live streamed games. Users with a profile have access to live streaming games, and preferably, while watching, can record, sync and save their own audio track over the live streaming video. All saved information will be accessible in their “archives.” During the game, user broadcasters can access a media guide, which provides an array of information that may include game information, up-to-date statistics, trends, injury notes, talking points, fun facts, scouting reports, quotes from various sources including but not limited to the league, officials and players, lineups, etc.

Other users will also be able to listen to a user broadcast of a live game. Without a username, password, and a profile, users can still browse the website and, like users with profiles, view headlines, updated sports stories/articles, and public media broadcasts clips. All broadcasts are made by users, for users, and are made public, although users have an option to keep broadcasts private, to view exclusively in their “archives.” All public broadcasts can be viewed and rated by other users. Ratings by other users help determine what will be made visible on the website and featured for others. They can also contribute to a user's popularity on the website and within its community.

Alternate embodiments can be implemented in schools, colleges, universities, etc. to develop confidence and public speaking abilities of students, especially those with a passive interest in sports, namely those who enjoy watching but are not active, participating sportspersons. Additionally, embodiments disclosed can be used in speech therapy, especially by patients suffering from stutters, bad orthodonture, cleft palate, stroke, Bell's palsy, or anything affecting the muscularity of the face or tongue. The simple act of practicing speaking via broadcasting a game or other event, and listening/evaluating the recording after will help improve articulation, fluency, resonance and public speaking Embodiments disclosed can be used as an effective and entertaining complement for people who need to practice and improve their speech.

For children in elementary and middle school, learning and recall are often dependent on the way a lesson plan is taught. Students often have trouble sitting still, concentrating, doing homework or paying attention for long periods of time. An embodiment can help students with short attention spans because the invention possesses the ability to engage students with video of entertaining events. Incorporating the service into the lesson plan can help children learn simple math, grammar, vocabulary and details about the event itself because they will be captivated by its entertainment value. The educational application extends to the high school, collegiate and graduate level as well.

Journalism schools, for example, do not possess this technology to appropriately teach students. “Play-by-play” and “color commentary” are taught by simply talking over a muted TV, even at top tier programs. Disclosed embodiments can be adapted to be easily incorporated into the lesson plan to enhance student learning and experience in the art. The service could extend into medical/dental schools as well. Students would have a highly interactive learning experience by watching online as doctors/dentists perform surgery, while a teacher (from an external location) commentates on the procedure in the classroom. The commentator could utilize various camera angles, pre-arranged in the room with the procedure, to highlight certain movements, anatomy and other vital techniques.

Additionally, embodiments disclosed can be used to record and play music. Instead of people “voicing over” video, they could “play” over it. Users could have the ability to write original scores for movies, live TV, sporting events, etc. and have people tune into this mash up. DJs often air silent streaming video on huge screens during their live shows because it serves as a more dramatic and entertaining visualizer. Using an external device, users could hook up a keyboard, guitar, or other electronic instrument/s to their computer or TV to make this application possible. The application also can be utilized to demonstrate musical technique, dance, or any other movement-oriented task. Additional embodiments could be used in a video game—users could commentate over what's happening in an arcade game that they are playing, or one of their friends or an external user is playing.

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure or the scope of the accompanying claims.

We claim:

1. A computer automated system comprising a memory coupled with a processing unit, and having instructions encoded thereon, wherein the instructions cause the computer automated system to:
receive audio and video data of an event;
encode or transcode the received data;
standardize the received data to internal presets;
embed timecode into the received data if timecode is not already present;
stream a low resolution proxy of the standardized data via a streaming server to a commentator computer;
receive a commentator recorded audio stream, which is combined with timecode metadata from the proxy stream and transmitted from the commentator computer;
combine the commentator audio stream with the audio and video data of the event;
buffer the resultant combined audio and video stream; and
broadcast the stream via the streaming server.

2. The computer automated system of claim 1 wherein the instructions further cause the computer automated system to archive the stream to a video repository.

3. The computer automated system of claim 1 further comprising video and audio receivers which comprise means for receiving video and audio from an event via the internet, using at least one of software transport, hardware encoder, and built in service.

4. The computer automated system of claim 1 further comprising audio receivers which comprise means for receiving an audio track from the commentator computer along with synchronization marks, via an internet connection.

5. The computer automated system of claim 1 wherein the commentator-computer is further comprised of:
means for receiving raw video and audio footage;
means for recording commentator narration and commentator visuals; and
means for adding synchronization marks to commentator narration.

6. The computer automated system of claim 1 wherein the computer automated system is further comprised of:
means for distributing raw event feed to a plurality of commentators via the internet.

7. The computer automated system of claim 1 wherein the computer automated system is further comprised of:
a video repository for storing audio and video content.

8. The computer automated system of claim 1 wherein the computer automated system is further comprised of:
a server for encoding and transcoding of data; and
means for standardizing the data to internal presets, and for adding timecode if it is not already present.

9. The computer automated system of claim 1 wherein the computer automated system is further comprised of:
a streaming server which serves as a means for streaming a low resolution proxy video of the standardized data, with embedded timecode, to a single or plurality of commentators.

10. The computer automated system of claim 9 further comprising a commentator sub-system, which is further comprised of a:
means for receiving the low resolution proxy video with embedded timecode;
means for recording commentary;
means for encoding the received timecode from the raw stream into the new audio commentary feed; and
means for buffering locally on the sub-system.

11. The computer automated system of claim 10 further comprising means for transmitting the commentator recorded audio stream to the data center wherein only the commentator recorded audio is transmitted.

12. The computer automated system of claim 1 wherein the commentator computer comprises, in its interface, a telestrator functionality which is comprised of a:
means to draw onto and over the received video stream;
means to transmit the drawn data captured center either as a newly-formed stream or a series of png images in regular intervals with timecode embedded either in the metadata of the transmission or of the png file; and
means for layering the transmitted stream or png files with the original broadcast and for combining with the original video.

13. In a computer automated system comprising a memory coupled to a processing unit, a method for creating personalized layered audio and video streams for broadcasting, comprising:
receiving audio and video data of an event;
encoding or transcoding the received data;
standardizing the received data to internal presets;
embedding timecode into the received data if timecode is not already present;
streaming a low resolution proxy of the standardized data via a streaming server to a commentator computer;
receiving a commentator recorded audio stream, which is combined with timecode metadata from the proxy stream and transmitted from the commentator computer;
combining the commentator audio stream with the audio and video data of the event;
buffering the resultant combined audio and video stream; and
broadcasting the stream via the streaming server.

14. The method of claim 13 further comprising archiving the broadcast stream to a video repository.

15. The method of claim 13 wherein the receiving audio and video data of the event comprises receiving the data via at least one of TCP/IP hardware and software decoders.

16. The method of claim 13 wherein the transmitting of reconfigured data comprises transmitting audio and timecode from the video back to the data center.

17. The method of claim 13 wherein receiving video and audio data from the event comprises receiving the data via the internet, using at least one of software transport, hardware encoder, and built in service.

18. The method of claim 13 wherein receiving a commentator recorded audio stream is further comprised of receiving an audio track from the commentator's computer along with synchronization marks, via an internet connection.

19. The method of claim 13 further comprising, at the commentator's computer:
receiving raw video and audio footage;
recording commentator narration and commentator visuals; and
adding synchronization marks to commentator narration.

20. The method of claim 13 further comprising distributing raw event feed to a plurality of commentators via the internet.

21. The method of claim 13 further comprising at a commentator sub-system:
receiving the low resolution proxy video with embedded timecode;
recording commentary;
encoding the received timecode from the raw stream into the new audio commentary feed; and
buffering the commentary feed locally on the sub-system.

22. The method of claim 13 further comprising transmitting the commentator recorded audio stream to the data center wherein only the commentator recorded audio is transmitted.

23. The method of claim 13 wherein combining the commentator audio stream with the audio and video data of the event further comprises combining a telestrator functionality, which comprises:
drawing onto and over the received video stream;
transmitting any drawn data captured either as a newly-formed stream or a series of png images in regular intervals with timecode embedded either in the metadata of the transmission or of the png file;
layering the transmitted stream or png files with the original broadcast and for combining with the original video.

24. A computer automated system for broadcasting, comprised of a memory and a processing unit coupled to the memory, wherein the computer automated system is further comprised of a data center, which comprises:
a single or plurality of video and audio receivers comprised of means for receiving live video and audio, and for receiving audio voiceover from a commentator computer;
a server for encoding and transcoding of data;
a streaming server comprised of means for streaming a low resolution proxy data of event feed along with timecode to a commentator computer;
means for combining received live video and audio with audio voiceover from the commentator;
a video repository; and
a web server comprised of means for serving broadcastable content and for scheduling and automating tasks.

25. The computer automated system of claim 24, wherein the commentator computer further comprises:
means for receiving the low resolution proxy video with embedded timecode;
means for recording commentary;
means for encoding the received timecode from the raw stream into the new audio commentary feed;
means for buffering locally on the sub-system; and
means for sending the buffered, recorded commentary to the data center.
